(19) United States
(12) Patent Application Publication
(10) Pub. No.: US 2008/0127451 A1
(43) Pub. Date: Jun. 5, 2008

(54) Caster with Kickstand

(76) Inventor: Adrian A. Bruno, Rolling Meadows, IL (US)

Correspondence Address: DAVID I. ROCHE;BAKER & MCKENZIE LLP, 130 EAST RANDOLPH DRIVE, CHICAGO, IL, 60601, US

(21) Appl. No.: 11/565,071

(22) Filed: Nov. 30, 2006

(51) Int. Cl. B60B 33/00

(52) U.S. Cl. 16/32

(57) ABSTRACT

The present invention is directed to a tip-resisting caster which is adapted to provide tip resistance for a barbecue grill when tip tested for compliance with Canadian Standards Agency standard no. 1.6, Section 2.18.4 The preferred caster of the present invention comprises a chassis, a connector such as a flange or a post, at least one wheel, and a kickstand or the like. The connector depends upwardly from the chassis, thereby defining a longitudinal axis for the caster, and is operable for attachment to an object desired to be rolled. There are preferably two wheels which are connected to the chassis about a rotational axis, whereby the rotational axis is generally transverse to the longitudinal axis and is offset from the longitudinal axis towards a rear side of the caster. Due to the offset between the rotational axis and the longitudinal axis, the wheels are biased towards a rear side of the caster. The kickstand is rigidly attached to the caster and projects from the caster towards a front side of the caster, whereby a line drawn tangent with both the wheel and the kickstand is offset from the longitudinal axis by at least 75°. In this manner, the kickstand is adapted to contact a horizontal surface when the barbecue grill is inclined to 15°.

### FIELD OF THE INVENTIONS

The inventions described and claimed herein relate generally to casters which include tip resisting features. More specifically, the inventions described herein incorporate a caster with a forwardly projecting kickstand for an outdoor barbecue grill for complying with CSA Standard No. 1.6, Section 2.18.4 (ANSI Z21.58).

### BACKGROUND OF THE INVENTIONS

The Canadian Standards Agency (“CSA”) instituted a standard which mandates that outdoor barbecue grills must be able to resist tipping over when tipped in any direction at an angle of 15°. To satisfy this standard, many manufacturers have employed means to lower the center of gravity of the grill or to move the base contact point outward, so that the center of gravity stays inside of the base contact point when tipped 15°. While these methods have been successfully used to satisfy the CSA standard, there are substantial drawbacks to this approach.

A first method currently used to lower the center of gravity is to utilize counterweights which are placed low on the barbecue grill. Obviously, this method substantially increases the overall weight of the barbecue grill. In some cases, the counterweights make the grill unwieldy, not only to deliver to the customer, but in actual use by the customer. Most barbecue grills are intended to be movable from one location to another and some grills are intended to be fully portable. Each added pound frustrates these purposes, since it makes the grill hard to push and hard to lift. Moreover, the increased weight of the barbecue grill not only increases the manufacturing cost for the grill, but also increases the shipping cost.

Another method used by manufacturers is reducing the weight of the cooking chamber. While this solution may aid in lowering the center of gravity, at the same time it reduces the quality and effectiveness of the barbecue grill. First of all, cooking chambers are typically fabricated out of thick walled metal to withstand the heat generated by the barbecue grill. Furthermore, most customers demand a solidly built barbecue grill which will be capable of withstanding time and the elements. Reducing the wall thickness may lower the center of gravity, but it would also reduce the perceived quality of the grill and may cause the grill to degrade faster.

Reducing the volume of the cooking grid, an internal component of the cooking chamber, is also a potential method for lowering the center of gravity. However, it is likely that a reduction in the volume of the cooking grd will substantially degrade the functionality of the grill. Many users employ a cooking technique called searing. Searing involves subjecting meat to a very high heat, sometimes just for a short period of time. Searing is generally most effective when the cooking grid is provided with a large volume, such that the grid is able to store great amounts of energy. In this manner, the grid is able to transfer such heat to the meat quickly, without a substantial reduction in temperature. As such, reducing the volume of the cooking grid with negatively impact a grill's searing capabilities.

Another method used in the art to prevent tipping is to increase the depth of the grill assembly. Increasing the depth of the grill moves the base contact point outward such that the center of gravity will not bear over the base contact point when the grill is tipped 15°.

### SUMMARY OF THE INVENTIONS

The various embodiments of the present inventions not only provide a satisfactory means for complying with the CSA standards, but also do not suffer from the above-mentioned problems of the prior art. The preferred grill of the present invention includes a tip-resisting caster, which counteracts a moment of a barbecue grill with respect to a caster which may be present when the grill is placed in a tipped condition. By incorporating the tip-resisting caster of the present invention into the grill design, the grill manufacturer need not take steps to lower the grill center of gravity, by either reducing the weight of the cooking chamber or by adding counterweights.

The preferred tip resisting caster of the present invention is in many ways similar to prior art casters, in that it generally comprises a chassis, a connector for connecting to an object (i.e. barbecue grill), wheels, and a wheel lock. The connector is preferably a post or the like, although it could be a flange or a bracket. The wheels are preferably connected to the chassis along a rotational axis (i.e. axle), whereby the rotational axis is offset from the post. In this manner, the wheels will trail behind the post regardless of the direction in which the barbecue grill is pushed.

Where the preferred tip-resisting caster differs from the prior art is with respect to a tip support which projects from chassis, away from the post in a direction opposite from the rotational axis of the wheels. Accordingly, the tip support will almost always point in the direction of travel of the barbecue grill. The tip support is adapted to contact a horizontal surface when a barbecue grill is tipped approximately 15°. In this manner, the tip support presses against the horizontal surface thereby preventing rotation of the barbecue grill and providing a counteracting moment, in compliance with the CSA standards.

### BRIEF DESCRIPTION OF THE DRAWINGS

These and other features, aspects, objects, and advantages of the inventions described and claimed herein will become better understood upon consideration of the following detailed description, appended claims, and accompanying drawings where:

FIG. 1 is front view of a barbecue grill on a horizontal surface, the barbecue grill being tipped to an angle of 15° and having a preferred caster of the present invention;

FIG. 2 is a perspective view of the preferred caster of the present inventions;

FIG. 3 is a side view of the preferred caster of the present inventions; and,

FIG. 4 is a front view of the preferred casters of the present inventions.

It should be understood that the drawings are not necessarily to scale and that the embodiments are sometimes illustrated by graphic symbols, phantom lines, diagrammatic representations and fragmentary views. In certain instances, details which are not necessary for an understanding of the inventions described and claimed herein or which render other details difficult to perceive may have been omitted. It should be understood, of course, that the inventions described herein are not necessarily limited to the particular embodiments illustrated herein.

Like reference numerals will be used to refer to like or similar parts from figure to figure in the following description of the drawings.

### DETAILED DESCRIPTION OF THE DRAWINGS

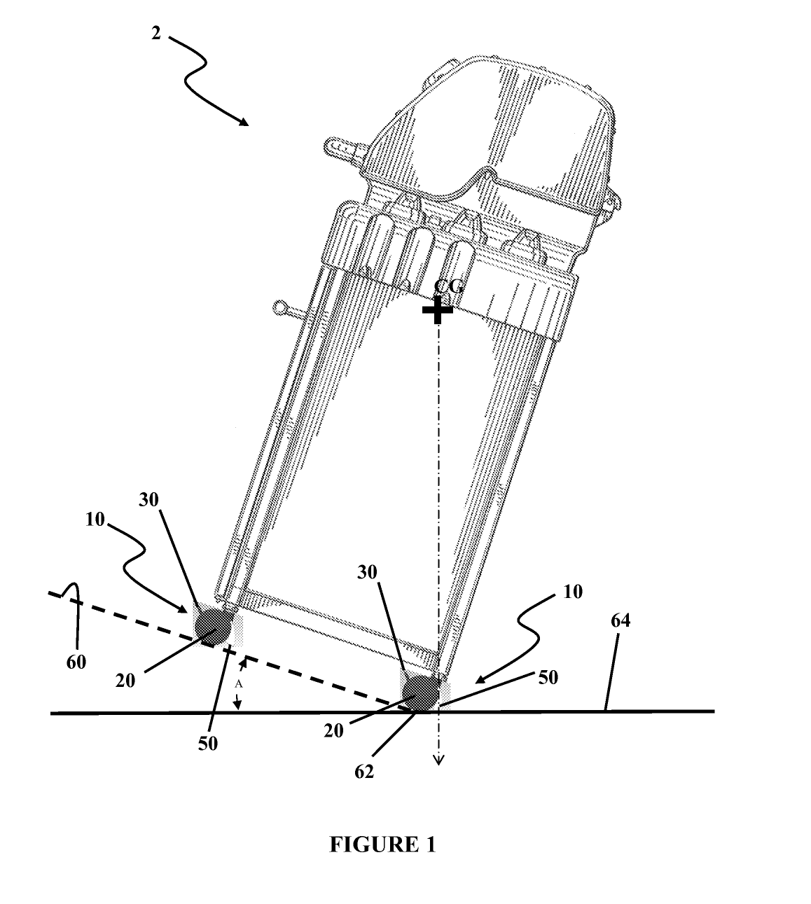

Referring first to FIG. 1, a barbecue grill 2 is shown on a proposed test rig for CSA 1.6, Section 2.18.4, the test rig essentially comprising a horizontal surface 64. The grill 2 is tipped to an angle of 15° with respect to the horizontal surface 64, although the grill 2 can be inclined at other angles as required. It is suggested herein that the grill 2 will meet the standard's requirements if it will not tip over when the grill 2 is positioned at this angle. Any method can be used to tip the grill 2, such as manually lifting one end of the grill 2 (as shown in FIG. 1). Regardless of which test method is used, it may be necessary to chock the caster 10 towards the angle of tip to prevent the grill 2 from rolling during the test.

FIG. 1 depicts how the grill 2 might be tested for tip resistance. In FIG. 1, the grill 2 is depicted in a tipped condition (inclined to angle A, which is preferably approximately 15°) with the leading caster(s) 10 contacting the horizontal surface 64 at the point 62. While a typical grill 2 which does not utilize counterbalancing or the like may tip over in such a test condition, it is suggested herein that the same grill 2 may not tip over if it included the preferred tip-resisting caster 10 of the present invention, as shown in FIG. 1.

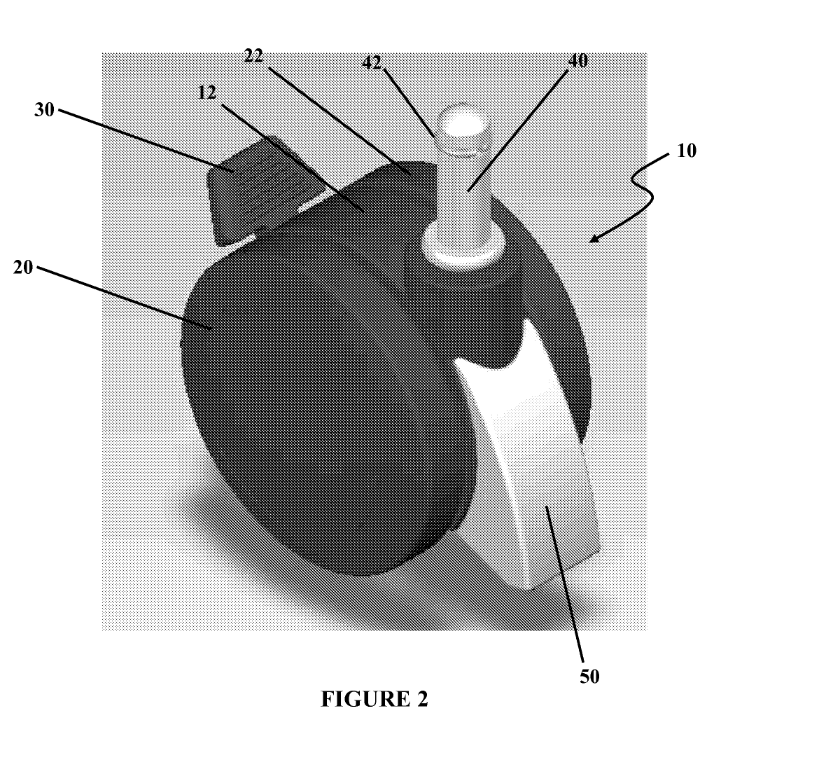

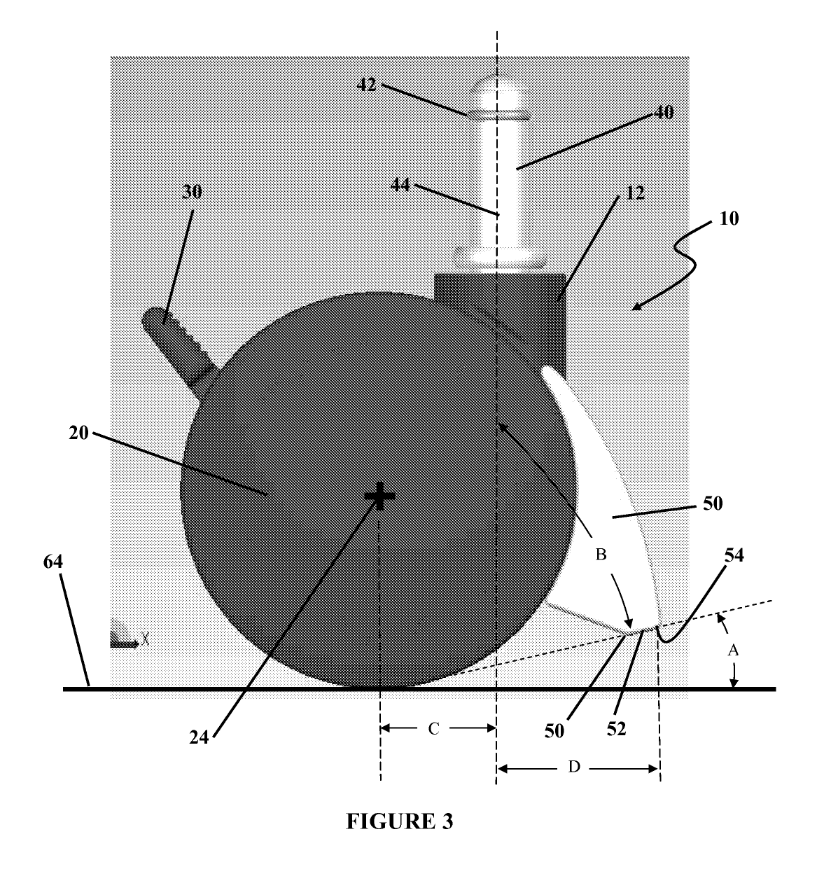

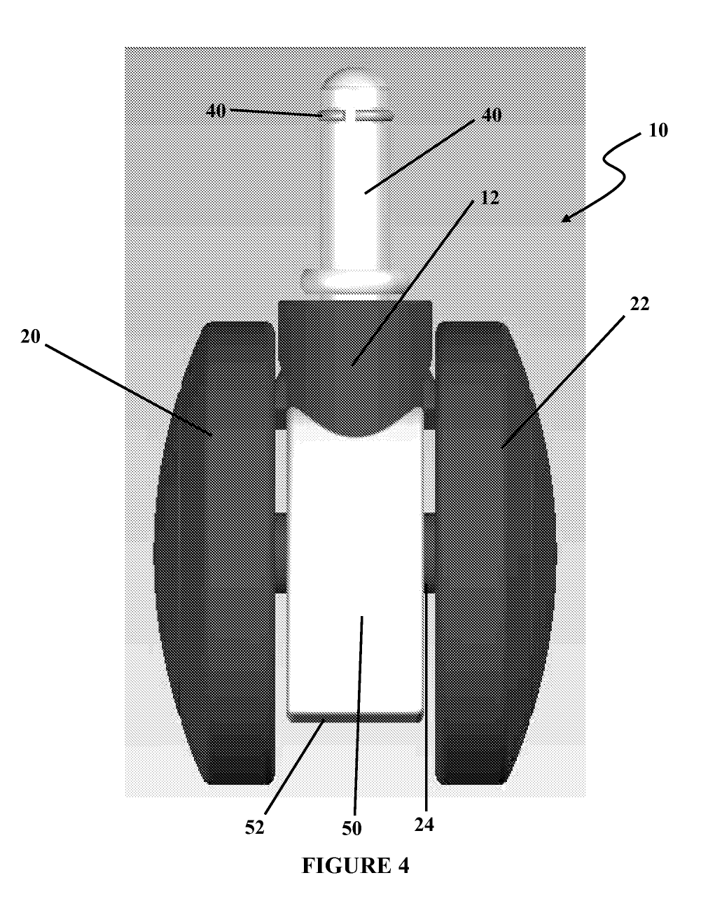

Referring generally to FIGS. 2-4, the preferred tip-resisting caster 10 is shown. Note that while the tip-resisting caster 10 is shown and discussed with reference to a barbecue grill, it is contemplated that the caster 10 can be used on any object desired to be rolled. The caster 10 preferably comprises a chassis 12, at least one wheel 20, 22, a wheel lock 30, a connector 40, and a tip support 50.

The preferred chassis 12 of the caster 10 can be characterized as the main support structure or frame for the caster 10, whereby each component of the caster 10 is generally connected directly to the chassis 12, although such a configuration is not necessary. There are preferably two wheels 20, 22 which are positioned on opposite sides of the chassis 12 and are connected to the chassis 12 along at least one axle 24, the axle 24 defining a rotational axis, which allows the wheels 20, 22 to rotate. Note that while the caster 10 is shown with two wheels 20, 22, the invention is not limited as such; more or less wheels 20, 22 may be sufficient. It is also contemplated that the caster 10 can comprise one axle 24 where all wheels 20, 22 are interconnected, or can comprise a separate axles 24, where each wheel 20, 22 moves independently of one another. The preferred wheel lock 30 of the present invention includes a lever or tab which prevents rotational movement of the wheels when pressed. Although the wheel lock structure is not described in detail herein, structure for locking caster wheels are well known in the art and need not be repeated herein. The connector 40 preferably upwardly projects from the chassis 12 and includes means for connecting the caster 10 to the barbecue grill 2. While the connector 40 can be any type of connector known or unknown in the art, including a flange and a bracket, the connector 40 is preferably a male connector such as post 40 (or prong or stem or the like) which is adapted to mate with a female connector (not shown) on the barbecue grill 2. This configuration could be reversed, however, wherein the connector 40 is a female connector which is adapted to mate with a male connector on the barbecue grill 2. The preferred connector 40, a post, preferably includes a retaining ring 42 which is adapted to lock the post 40 in engagement with the female connector. The connector 40 supports a load (i.e. the grill cart 2) along a longitudinal axis 44, whereby the weight of the load bears down on the caster 10 along the longitudinal axis 44.

The tip support 50 forwardly projects from the chassis and, preferably, the tip support 50 forwardly projects from the longitudinal axis 44 of the caster 10 as depicted in the figures. The tip support 50 is adapted to counteract a rotational moment which may be present when the barbecue grill 2 is in an inclined orientation. The tip support 50 does this by contacting a ground surface 64 when the grill 2 is inclined to a predetermined angle relative to the ground surface 64, thus preventing further rotation. This concept is more easily explained with reference to FIG. 1. In FIG. 1, the grill 2 is shown tipped at an angle of 15° (see angle A, defining the angle between ground surface 64 and the plane 60). This angle is set consistent with the requirements of CSA No. 1.6, although the angle can be varied depending upon the tip resistance needs of the object 2 or the desired safety margin. The grill 2 has a center of gravity CG which, for example purposes only, is shown bearing down on the caster past (or to the right of) the axle 24 of the caster (and the point of contact of the wheels 20,22 with the horizontal surface 64), but not past the contact point between the tip support 50 and the horizontal surface 64. In the event that this hypothetical barbecue grill 2 did not have the tip support 50, the barbecue grill 2 may tip over since the center of gravity CG extends past the wheel's point of contact 62 with the horizontal surface 64. However, since the center of gravity CG does not extend past the point where the tip support 50 contacts the horizontal surface 64, the tip support 50 effectively prevents the grill 2 from tipping over. In essence, the tip support 50 moves the base contact point outward such that the CG remains inside of the base contact point.

The tip support 50 of the present invention can be generally characterized as a kickstand 50, whereby the kickstand 50 projects from the caster 10 towards a front side of the caster 10 and whereby a line drawn tangent with both the wheel and the kickstand is offset from a horizontal surface 64 by less than 15° (see Angle A). Accordingly, the tangent line is also offset from the longitudinal axis 44 by at least 75° (see Angle B), the longitudinal axis being generally parallel with vertical when the grill 2 is placed on a horizontal surface. Although Angle A is shown at approximately 15° to prevent tipping when the grill is inclined to 15°, it is contemplated that Angle A can vary depending upon the desired tip resistance. For instance, if a tip resistance is desired at 10°, to include additional safety margin or to comply with some other standard or requirement, the tip support 50 could be redesigned such that Angle A is approximately 10°.

Preferably, the tip support 50 includes a support surface 52 which is generally aligned with the line drawn tangent with the wheel 20, 22 and the kickstand 50. The preferred support surface 52 generally distributes the weight of the grill 2 to prevent breakage and/or to prevent significant displacement of the kickstand of the tip support 50 during the tip test and actual tipping conditions. The support surface 52 has a front edge 54 which preferably extends a distance D from the longitudinal axis, a distance which is preferably equal to or greater than the distance C. Furthermore, the support surface 52 has a rear edge 56 which is distanced slightly above the horizontal surface (i.e., when the grill 2 is not tipped) to provide clearance for caster 10 to easily roll over small pebbles and the like.

Although the inventions described and claimed herein have been described in considerable detail with reference to certain preferred embodiments, one skilled in the art will appreciate that the inventions described and claimed herein can be practiced by other than the preferred embodiments, which have been presented for purposes of illustration and not of limitation. Therefore, the spirit and scope of the appended claims should not be limited to the description of the preferred embodiments contained herein.

I claim:

1. A tip-resisting caster comprising:
a chassis, a connector, at least one wheel, and a kickstand;
the connector depending upwardly from the chassis, defining a longitudinal axis for the caster, and being operable for attachment to an object desired to be rolled;
the at least one wheel being connected to the chassis about a rotational axis, the rotational axis being generally transverse to the longitudinal axis and being offset from the longitudinal axis towards a rear side of the caster; and,
the kickstand being rigidly attached to the caster and projecting from the caster towards a front side of the caster, whereby a line drawn tangent with both the wheel and the kickstand is offset from the longitudinal axis by at least 75°.

2. The tip-resisting caster of claim 1 wherein the line is offset from the longitudinal axis by approximately 80°.

3. The tip-resisting caster of claim 1 wherein the line is offset from the longitudinal axis by approximately 75°.

4. The tip-resisting caster of claim 1 wherein the kickstand comprises a support surface, whereby the support surface is generally aligned along a plane which is offset from the longitudinal axis by at least 75°.

5. The tip-resisting caster of claim 4 wherein the support surface has a leading edge which is positioned a first distance forward of the longitudinal axis and wherein the rotational axis is positioned a second distance rear of the longitudinal axis, the first distance being equal to or greater than the second distance.

6. The tip-resisting caster of claim 5 wherein the caster has a clearance between a horizontal surface and the kickstand when the object is placed on the horizontal surface.

7. The tip-resisting caster of claim 1 wherein the connector is a post.

8. The tip-resisting caster of claim 1 wherein the connector is a flange.

9. The tip-resisting caster of claim 1 wherein the connector rotates with respect to the chassis about the longitudinal axis.

10. The tip-resisting caster of claim 1 wherein the connector rotates with respect to the object about the longitudinal axis.

11. A tip-resisting caster comprising:
a chassis, a post, a first and a second wheel, and a kickstand;
the post depending upwardly from the chassis and being operable for attachment to an object desired to be rolled;
the first and second wheels being connected at opposing sides of the chassis about a rotational axis; and,
the kickstand being rigidly attached to the caster whereby when the object is tipped approximately 15° on a horizontal surface, the kickstand contacts the horizontal surface.

12. The tip-resisting caster of claim 11 wherein the kickstand comprises a support surface, the support surface being adapted to contact the horizontal surface when the object is tipped.

13. The tip-resisting caster of claim 12 wherein the post defines a longitudinal axis and the support surface being offset from the longitudinal axis by at least 75°.

14. The tip-resisting caster of claim 11 wherein the support surface is offset from the longitudinal axis by approximately 75°.

15. The tip-resisting caster of claim 11 wherein the support surface is offset from the longitudinal axis by approximately 80°.

16. The tip-resisting caster of claim 12 wherein the support surface has a leading edge which is positioned a first distance forward of the longitudinal axis and wherein the rotational axis is positioned a second distance rear of the longitudinal axis, the first distance being equal to or greater than the second distance.

17. The tip-resisting caster of claim 11 wherein the caster has a clearance between a horizontal surface and the kickstand when the object is placed on the horizontal surface.

18. The tip resisting caster of claim 11 whereby the rotational axis of the wheels and at least a portion of the kickstand are located on an opposite sides of the post, whereby the kickstand is biased in the direction of travel of the caster.

19. A tip-resisting caster comprising:
a chassis having at least one wheel, a connector for connection to an object desired to be rolled, a tip support;
the caster having a longitudinal axis which is vertical when the object is positioned on a horizontal surface;
the tip support being positioned at a leading edge of the caster, whereby when the object is inclined on a horizontal surface such that the longitudinal axis is offset from the horizontal surface by approximately 75°, the tip support contacts the horizontal surface.

20. A tip-resisting caster comprising:
a chassis having at least one wheel, a connector for connection to an object desired to be rolled, a tip support;
the caster having a longitudinal axis which is vertical when the object is positioned on a horizontal surface;
the tip support being positioned at a leading edge of the caster, whereby a line drawn tangent with both the wheel and the tip support is offset from the longitudinal axis by at least 75°.
